(19) United States
(12) Patent Application Publication
(10) Pub. No.: US 2025/0130840 A1
(43) Pub. Date: Apr. 24, 2025

(54) METHOD TO IMPROVE SCANNER REDIRECTION PERFORMANCE WITH NESTED MODE

(71) Applicant: Omnissa, LLC, Mountain View, CA (US)

(72) Inventors: Huiyong HUO, Beijing (CN); Zhongzheng TU, Beijing (CN); Mingsheng ZANG, Beijing (CN); Kai XIANG, Beijing (CN); Ning GE, Beijing (CN); Tao JIN, Beijing (CN)

(21) Appl. No.: 18/531,228

(22) Filed: Dec. 6, 2023

(30) Foreign Application Priority Data
Oct. 18, 2023 (WO) PCT/CN2023/125146

(51) Int. Cl. G06F 9/455

(52) U.S. Cl. CPC G06F 9/45558; G06F 2009/4557

(57) ABSTRACT

A scanner redirection method for a remote desktop computer system that includes a client computer, a first virtual machine (VM), and a second VM, wherein the client computer communicates with the first VM via a first remote desktop session, and the first VM communicates with the second VM via a second remote desktop session, includes the steps of: receiving by the first VM from the second VM, a request for an image and an identifier (ID) of an image capturing device connected to the client computer; forwarding by the first VM to the client computer, the request for the image and the ID of the image capturing device; and upon receiving the image from the client computer, transmitting by the first VM to the second VM, the image received from the client computer.

### CROSS-REFERENCE

This application is based upon and claims the benefit of priority from International Patent Application No. PCT/CN2023/125146, filed on Oct. 18, 2023, the entire contents of which are incorporated herein by reference.

### BACKGROUND

Many organizations rely on remote desktop (RD) services to provide lean, flexible computing environments. Scanner redirection is an important feature required by such organizations. Through scanner redirection, applications on remote computers acquire images from image capturing devices (ICDs) that are connected to separate client computers, i.e., ICDs that are not directly connected to the remote computers. As an added complexity, some organizations rely on what is known as a “nested mode” for their RD services.

Through nested mode, a user of a client computer such as a laptop indirectly accesses a target agent such as a virtual machine (VM) executing on a remote server. To indirectly access the target VM, the user first establishes an RD session between the client computer and a first agent such as a VM executing on a different remote server, referred to herein as a “first-hop VM.” Then, the user establishes a second RD session between the first-hop VM and the target VM, the target VM also referred to herein as a “second-hop VM.” There may be various reasons for such an arrangement such as the client computer not having direct access to the second-hop VM due to an organization's security policies.

When using scanner redirection generally, a remote computer that consumes images is not directly connected to the ICD that creates the images. The remote computer thus relies on an RD session with a client computer that is connected to the ICD. However, processing of scan-related commands by the computers to realize scanner redirection is typically inefficient and often results in crashes. Furthermore, such processing is made even more complex and inefficient when relying on nested mode. In such a case, the remote computer is not even directly connected to the client computer to transmit scan-related commands thereto. A robust and efficient method is needed to realize scanner redirection for organizations that rely on nested mode.

### SUMMARY

Accordingly, one or more embodiments provide for an RD computer system, wherein the RD computer system includes a client computer, a first-hop VM, and a second-hop VM. The client computer includes image capturing software that is configured to communicate with ICDs. According to a first embodiment, the image capturing software includes a “data source,” which is a component that communicates with the ICDs, e.g., to acquire images therefrom. According to a second embodiment, the image capturing software is an image capture core, which is a service running in an operating system (OS) that exposes application programming interfaces (APIs) for communicating with the ICDs. According to a third embodiment, the image capturing software is a scanner-access-now-easy (SANE) module that similarly exposes APIs for communicating with the ICDs.

One or more embodiments provide a scanner redirection method for an RD computer system that includes a client computer, a first VM, and a second VM. The client computer communicates with the first VM via a first RD session. The first VM communicates with the second VM via a second RD session. The scanner redirection method includes the steps of: receiving by the first VM from the second VM, a request for an image and an identifier (ID) of an ICD connected to the client computer; forwarding by the first VM to the client computer, the request for the image and the ID of the ICD, wherein in response to the request for the image, the client computer acquires the image from the ICD and then transmits the image to the first VM; and upon receiving the image from the client computer, transmitting by the first VM to the second VM, the image received from the client computer.

Further embodiments include a non-transitory computer-readable storage medium comprising instructions that cause an RD computer system to carry out the above scanner redirection method, as well as an RD computer system configured to carry out the above scanner redirection method.

### BRIEF DESCRIPTION OF THE DRAWINGS

FIG. 1 is a block diagram of an RD computer system in which embodiments may be implemented.

FIG. 2 is a block diagram illustrating communication between a client computer, a first-hop VM, and a second-hop VM of the RD computer system.

FIG. 3 is a block diagram of the client computer and a group of ICDs connected to the client computer, according to a first embodiment.

FIG. 4 is a block diagram of the second-hop VM, according to embodiments.

FIG. 5 is a flow diagram of a method performed by the client computer, the first-hop VM, and the second-hop VM to select, for scanner redirection functionalities for the second-hop VM, an ICD connected to the client computer, according to embodiments.

FIG. 6 is a flow diagram of a method performed by the second-hop VM to acquire one or more images through scanner redirection, according to embodiments.

FIG. 7 is a flow diagram of a method performed by the first-hop VM to enable the second-hop VM to acquire an image, according to embodiments.

FIG. 8 is a flow diagram of a method performed by the client computer to acquire an image for the second-hop VM, according to the first embodiment.

FIG. 9 is a block diagram of the client computer and the group of ICDs connected to the client computer, according to a second embodiment.

FIG. 10 is a flow diagram of a method performed by the client computer to acquire an image for the second-hop VM, according to the second embodiment.

### DETAILED DESCRIPTION

Techniques are described for realizing scanner redirection during an RD session between a client computer, a first-hop VM, and a second-hop VM. The second-hop VM executes an application that consumes images from ICDs, and the ICDs are connected to the client computer. To acquire an image from an ICD, the application of the second-hop VM requests the image from the first-hop VM. The first-hop VM then forwards the request to the client computer. The client computer then acquires the image from the ICD and transmits it to the first-hop VM to be forwarded to the second-hop VM.

To enable the above acquiring of the image, the client computer, first-hop VM, and second-hop VM make use of various RD software. There is “agent” RD software, which is software that enables hosting of RDs. There is also “client” RD software, which is software that enables accessing of such RDs. According to embodiments, the client computer includes client RD software for accessing an RD hosted by agent RD software of the first-hop VM. In addition to agent RD software, the first-hop VM includes client RD software for accessing an RD hosted by agent RD software of the second-hop VM.

Such client and agent RD software enable the above acquiring of the image as follows. The agent RD software of the second-hop VM requests the image from the client RD software of the first-hop VM. Next, the agent RD software of the first-hop VM forwards the request to the client RD software of the client computer. Then, the client RD software of the client computer acquires the image and returns it to the agent RD software of the first-hop VM. Finally, the client RD software of the first-hop VM forwards the image to the agent RD software of the second-hop VM.

According to a first embodiment, the client computer and the second-hop VM utilize the same scanning protocol such as the TWAIN protocol. Pursuant to the common scanning protocol, applications of the client computer and second-hop VM utilize “data source managers” and “data sources.” For the second-hop VM, the data source manager communicates with a “virtual” data source, the virtual data source requesting images from the first-hop VM. For the client computer, the data source manager communicates with a data source that acquires images from ICDs.

According to other embodiments, the client computer has a different OS than that of the second-hop VM. As a result, the client computer uses one scanning protocol such as the Image Capture (ICA) Framework or the SANE API, and the second-hop VM uses another scanning protocol such as the TWAIN protocol. Pursuant to its respective scanning protocol, the second-hop VM still utilizes a data source manager and virtual data source. Pursuant to the other scanning protocol, the client computer utilizes a separate component that communicates directly with ICDs (not through a separate data source component) to acquire images. These and further aspects of the invention are discussed below with respect to the drawings.

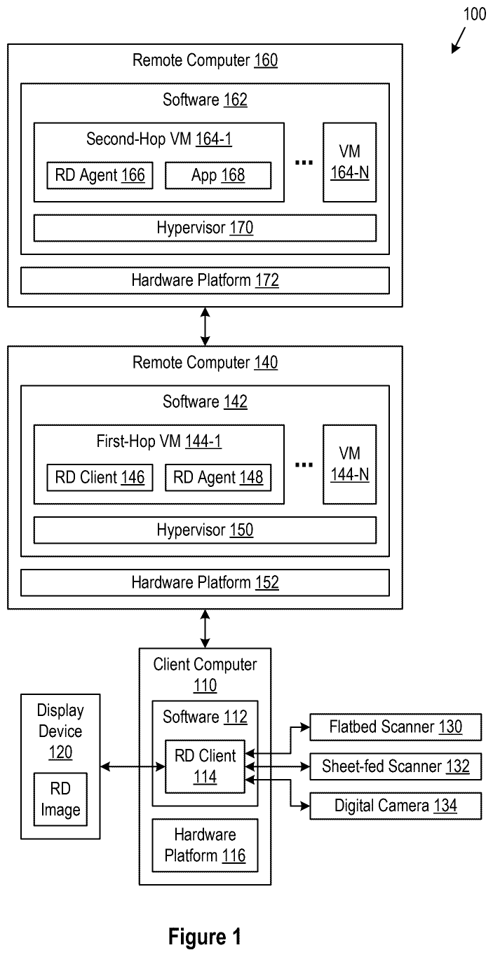

FIG. 1 is a block diagram of an RD computer system 100 in which embodiments may be implemented. RD computer system 100 includes a client computer 110 and remote computers 140 and 160 (remote from client computer 110). For example, client computer 110 may be a laptop, desktop computer, or server in a private data center controlled by a particular organization. Remote computers 140 and 160 may be servers provisioned in a private data center controlled by the particular organization, servers provisioned in a public data center that includes servers of other organizations, or servers provisioned in different data centers (each data center being either private or public).

Client computer 110 is constructed on a hardware platform 116 such as an x86 architecture platform. Hardware platform 116 includes conventional components of a computing device (not shown), such as one or more central processing units (CPUs), memory such as random-access memory (RAM), local storage such as one or more magnetic drives or solid-state drives (SSDs), and one or more network interface cards (NICs). The NIC(s) enable client computer 110 to communicate with remote computer 140 over a network (not shown) such as the Internet.

Hardware platform 116 supports software 112, which includes an RD client application 114 running on a commodity OS (not shown). For example, RD client 114 may be VMware Horizon® Client, available from VMware, Inc. The term “desktop” in remote desktop (RD) refers to an instance of an interactive environment provided by an OS and software applications, typically in the form of display and sound output and keyboard and mouse input. Through RD client 114, a user accesses RDs from any location.

Remote computers 140 and 160 are constructed on hardware platforms 152 and 172, respectively, such as x86 architecture platforms. Hardware platforms 152 and 172 each includes the conventional components of a computing device (not shown) discussed above with respect to hardware platform 116. CPU(s) of hardware platform 152 are configured to execute instructions such as executable instructions that perform one or more operations described herein, which may be stored in memory of hardware platform 152. NIC(s) of hardware platform 152 enable remote computer 140 to communicate with client computer 110 and remote computer 160 over networks (not shown) such as the Internet and a local area network (LAN), respectively. NIC(s) of hardware platform 172 enable remote computer 160 to communicate with remote computer 140 over a network (not shown) such as a LAN.

Hardware platforms 152 and 172 support software 142 and 162, respectively. Software 142 and 162 include hypervisors 150 and 170, respectively, which are virtualization software layers that support VM execution spaces. VMs 144 are concurrently instantiated and executed in the VM execution space of remote computer 140, and VMs 164 are concurrently instantiated and executed in the VM execution space of remote computer 160. For example, hypervisors 150 and 170 may be VMware ESX® hypervisors, available from VMware, Inc.

In embodiments illustrated herein, RDs are running in VMs 144 and 164. A first-hop VM 144-1 of VMs 144 hosts a first RD for the user. The first RD is accessible through an RD session between client computer 110 and remote computer 140. A second-hop VM 164-1 of VMs 164 hosts a second RD for the user, the second RD being accessible through an RD session between remote computers 140 and 160.

VM 144-1 includes an RD client application 146, which may be, e.g., another instance of VMware Horizon® Client, available from VMware, Inc. VMs 144-1 and 164-1 include RD agent applications 148 and 166, respectively. RD clients 114 and 146 and RD agents 148 and 166 are also referred to individually and collectively herein as RD software, RD clients 114 and 146 being client RD software, and RD agents 148 and 166 being agent RD software. RD agent 148 of first-hop VM 144-1 communicates with RD client 114 of client computer 110 to establish the RD session between client computer 110 and remote computer 140. Through that RD session, the user accesses the first RD. RD agent 166 of second-hop VM 164-1 communicates with RD client 146 of first-hop VM 144-1 to establish the RD session between remote computers 140 and 160. Through that RD session, the user accesses the second RD.

RD agent 166 periodically transmits an updated image of the second RD to RD client 146. RD agent 148 periodically transmits an updated image of the first RD to RD client 114. The image of the second RD is incorporated into the image of the first RD. Accordingly, through the image received at RD client 114, the user is able to see the second RD hosted by second-hop VM 164-1. To display the image, RD client 114 communicates with a display device 120 such as a monitor on which the user views the image.

RD client 114 is configured to execute a scanning protocol such as the TWAIN protocol, the ICA framework, or the SANE API. According to any of such scanning protocols, RD client 114 acquires images from three ICDs connected to client computer 110: a flatbed scanner 130, a sheet-fed scanner 132, and a digital camera 134. To do so, RD client 114 communicates with drivers (not shown) installed in software 112 to control the ICDs. RD client 114 transmits images to RD agent 148 of first-hop VM 144-1, and RD client 146 of first-hop VM 144-1 forwards the images to RD agent 166 of second-hop VM 164-1.

VM 164-1 includes an application 168, which consumes images created by the ICDs connected to client computer 110. Application 168 is modified to handle scanner redirection. For example, application 168 may be Adobe® Photoshop.® A particular configuration of RD computer system 100 is illustrated in FIG. 1. However, it should be recognized that one or more embodiments may be practiced with other computer system configurations.

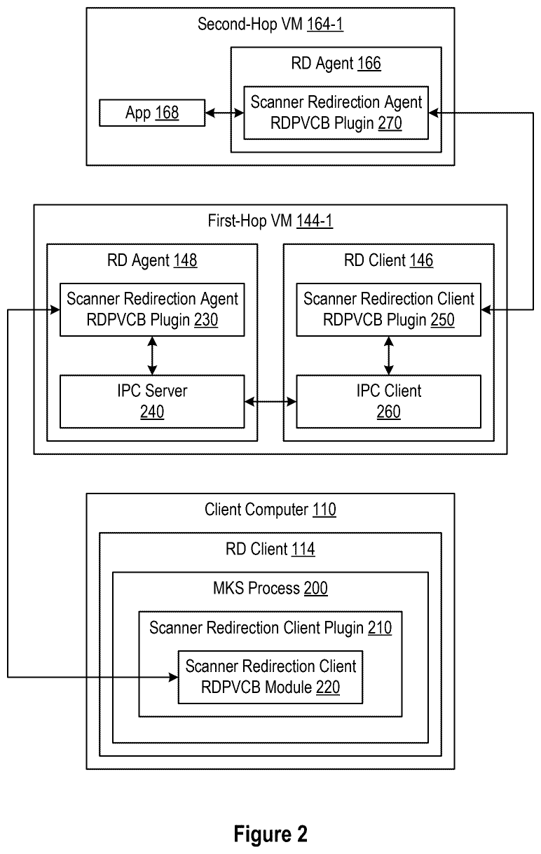

FIG. 2 is a block diagram illustrating communication between client computer 110, first-hop VM 144-1, and second-hop VM 164-1. RD client 114 of client computer 110 includes a mouse, keyboard, screen (MKS) process 200. When the user performs actions in the RD hosted by second-hop VM 164-1 such as clicking a mouse or typing on a keyboard, the user's actions are received by MKS process 200. MKS process 200 transmits the user's actions to RD agent 148, and RD client 146 forwards the user's actions to RD agent 166 to update the RD accordingly.

MKS process 200 includes a scanner redirection client plugin 210, which interacts with ICDs, e.g., to acquire images. Scanner redirection client plugin 210 includes a scanner redirection client remote desktop protocol virtual channel bridge (RDPVCB) module 220, referred to herein as client RDPVCB module 220. Client RDPVCB module 220 is communication software that is configured to communicate with first-hop VM 144-1 via transmission control protocol (TCP) or user datagram protocol (UDP) channels.

RD agent 148 of first-hop VM 144-1 includes a scanner redirection agent RDPVCB plugin 230, referred to herein as agent RDPVCB plugin 230. Agent RDPVCB plugin 230 is communication software that is configured to communicate with client computer 110 via the TCP or UDP channels of client RDPVCB module 220. RD client 146 of first-hop VM 144-1 includes a scanner redirection client RDPVCB plugin 250, which is communication software that is configured to communicate with second-hop VM 164-1 via TCP or UDP channels. RD agent 148 and RD client 146 also include an inter-process communication (IPC) server 240 and an IPC client 260, respectively. IPC server 240 and IPC client 260 establish a communication (IPC) channel through which RD agent 148 and RD client 146 communicate.

RD agent 166 of second-hop VM 164-1 includes a scanner redirection agent RDPVCB plugin 270. Agent RDPVCB plugin 270 is communication software that is configured to communicate with first-hop VM 144-1 via the TCP or UDP channels of client RDPVCB plugin 250. Agent RDPVCB plugin 270 is also configured to communicate with application 168. Scanner redirection functionalities are enabled via the communication path between application 168 and the ICDs, starting from agent RDPVCB plugin 270 to client RDPVCB plugin 250, then to agent RDPVCB plugin 230, and then to client RDPVCB module 220.

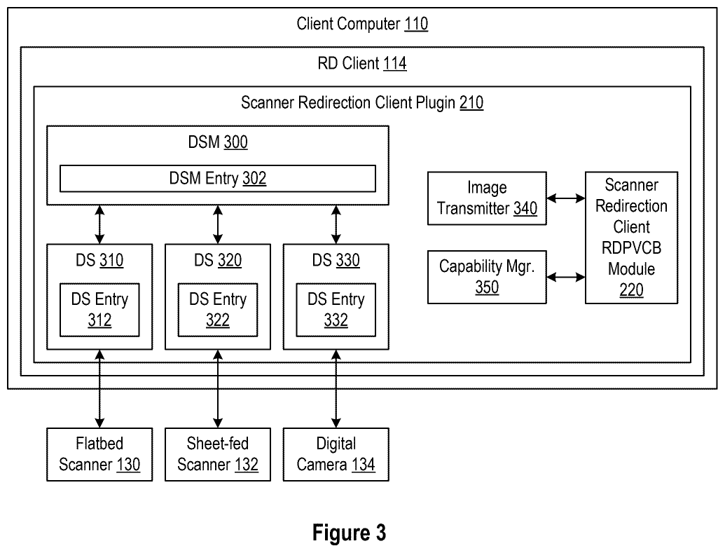

FIG. 3 is a block diagram of client computer 110 and ICDs 130, 132, and 134 connected thereto, according to the first embodiment. According to the first embodiment, client computer 110 uses the same scanning protocol as second-hop VM 164-1, e.g., the TWAIN protocol. In the example of FIG. 3, there are three drivers (not shown) installed in client computer 110 for controlling the depicted ICDs, one for controlling flatbed scanner 130, one for controlling sheet-fed scanner 132, and one for controlling digital camera 134.

Scanner redirection client plugin 210 includes a data source manager (DSM) 300 that communicates with data sources (DSs) 310, 320, and 330. DS 310 communicates with a driver to control flatbed scanner 130, DS 320 communicates with another driver to control sheet-fed scanner 132, and DS 330 communicates with another driver to control digital camera 134. To communicate with ICDs, scanner redirection client plugin 210 calls a “DSM entry” function 302 to provide commands to DSM 300. DSM 300 then calls a “DS entry” function 312, 322, or 332 to transmit commands to DS 310, 320 or 330, respectively. The relevant DS then returns results to DSM 300 via return values of the DS entry call. Similarly, DSM 300 returns results to scanner redirection client plugin 210 via DSM entry 302 return values.

When one of the DSs acquires an image from a corresponding ICD, scanner redirection client plugin 210 instructs an image transmitter 340 to transmit the image to first-hop VM 144-1 via client RDPVCB module 220. Additionally, one of the DSs may acquire capabilities from a corresponding ICD such as different supported resolutions for acquired images. Scanner redirection client plugin 210 instructs a capability manager 350 to transmit the capabilities to first-hop VM 144-1 via client RDPVCB module 220. If the user specifies to adjust settings for a particular ICD, scanner redirection client plugin 210 instructs the corresponding DS via DSM 300 to control the ICD to adjust those settings.

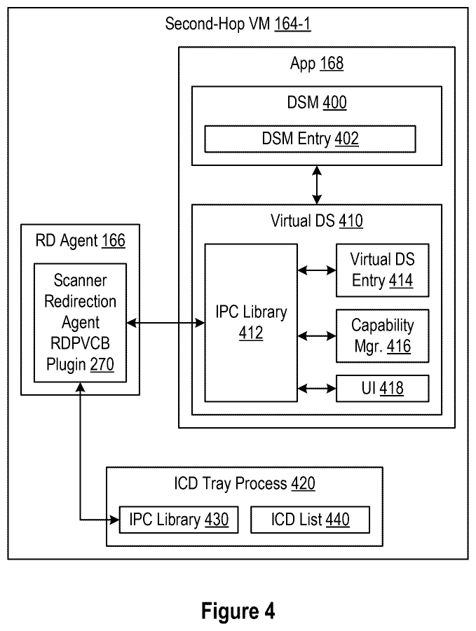

FIG. 4 is a block diagram of second-hop VM 164-1, according to embodiments. In addition to RD agent 166 and application 168, second-hop VM 164-1 includes an ICD tray process 420, which enables the user to select an ICD connected to client computer 110. ICD tray process 420 includes an IPC library 430, which facilitates communications (IPCs) with agent RDPVCB plugin 270. ICD tray process 420 also includes an ICD list 440, which lists identifiers (IDs such as names) of ICDs for which drivers have been installed in client computer 110. For example, to interact with ICD tray process 420, the user may click a toolbar menu item of second-hop VM 164-1, which results in ICD tray process 420 showing the contents of ICD list 440. The user may then click on an ID of an ICD to select that ICD for scanner redirection.

Application 168 includes a DSM 400 that communicates with a virtual DS 410. Instead of communicating directly with an ICD, virtual DS 410 communicates with first-hop VM 144-1, e.g., to request images. Specifically, application 168 calls a “DSM entry” function 402 to provide commands to DSM 400. DSM 400 then calls a “virtual DS entry” function 414 to transmit commands to virtual DS 410. Virtual DS 410 also returns results to DSM 400 via return values of virtual DS entry 414 calls. Similarly, DSM 400 returns results via DSM entry 402 return values.

In addition to virtual DS entry 414, virtual DS 410 includes an IPC library 412, a capability manager 416, and a UI 418. IPC library 412 facilitates communications (IPCs) between agent RDPVCB plugin 270, virtual DS entry 414, capability manager 416, and UI 418. Capability manager 416 caches capabilities of various ICDs such as different resolutions those ICDs can acquire images at, the capabilities being received from capability manager 350 of client computer 110. Capability manager 416 transmits those capabilities to UI 418 to be displayed to the user in the RD hosted by second-hop VM 164-1. Then, via UI 418, the user adjusts various settings such as which resolutions to acquire images at.

Capability manager 416 transmits specified adjustments to first-hop VM 144-1 via agent RDPVCB plugin 270. First-hop VM 144-1 forwards the specified adjustments to capability manager 350 of client computer 110 to be applied to a selected ICD. Through UI 418, the user also triggers the acquiring of one or more images by the selected ICD. Virtual DS 410 transmits such requests to first-hop VM 144-1 via agent RDPVCB plugin 270 to be forwarded to client computer 110. Then, virtual DS 410 receives one or more images from client computer 110 via first-hop VM 144-1.

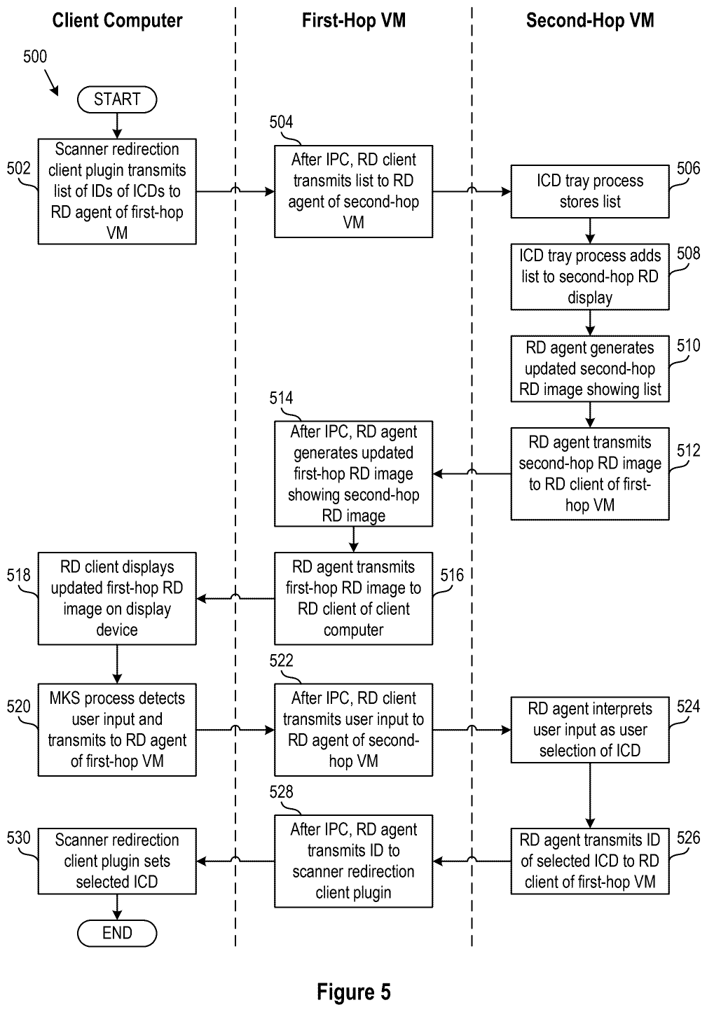

FIG. 5 is a flow diagram of a method 500 performed by client computer 110, first-hop VM 144-1, and second-hop VM 164-1 to select, for scanner redirection functionalities for second-hop VM 164-1, an ICD connected to client computer 110, according to embodiments. At step 502, scanner redirection client plugin 210 transmits a list of IDs of ICDs to RD agent 148 of first-hop VM 144-1 via a TCP or UDP channel between client RDPVCB module 220 and agent RDPVCB plugin 230. At step 504, agent RDPVCB plugin 230 transmits the list to client RDPVCB plugin 250 via IPC between IPC server 240 and IPC client 260. RD client 146 then transmits the list to RD agent 166 of second-hop VM 164-1 via a TCP or UDP channel between client RDPVCB plugin 250 and agent RDPVCB plugin 270.

At step 506, ICD tray process 420 stores the list as ICD list 440. At step 508, ICD tray process 420 adds ICD list 440 to the RD display of second-hop VM 164-1 (i.e., of the second-hop RD session). For example, ICD tray process 420 may add ICD list 440 in response to the user clicking a corresponding toolbar menu item. At step 510, RD agent 166 generates an updated RD image of the second-hop RD session, which shows ICD list 440. At step 512, RD agent 166 transmits the updated second-hop RD image to RD client 146 of first-hop VM 144-1 via the TCP or UDP channel therebetween.

At step 514, client RDPVCB plugin 250 transmits the updated second-hop RD image to agent RDPVCB plugin 230 via IPC between IPC client 260 and IPC server 240. RD agent 148 then generates an updated RD image of the first-hop RD session, which shows the updated second-hop RD image. At step 516, RD agent 148 transmits the updated first-hop RD image to RD client 114 of client computer 110 via the TCP or UDP channel therebetween. At step 518, RD client 114 displays the updated first-hop RD image on display device 120. At step 520, MKS process 200 detects user input, e.g., the user clicking a mouse. MKS process 200 then transmits the user input to RD agent 148 of first-hop VM 144-1 via the TCP or UDP channel therebetween.

At step 522, RD agent 148 transmits the user input to RD client 146 via IPC between IPC server 240 and IPC client 260. RD client 146 then transmits the user input to RD agent 166 of second-hop VM 164-1 via the TCP or UDP channel therebetween. At step 524, RD agent 166 interprets the user input as user selection of one of the ICDs of ICD list 440. At step 526, RD agent 166 transmits the ID of the selected ICD to RD client 146 of first-hop VM 144-1 via the TCP or UDP channel therebetween.

At step 528, client RDPVCB plugin 250 transmits the ID to agent RDPVCB plugin 230 via IPC between IPC client 260 and IPC server 240. RD agent 148 then transmits the ID to scanner redirection client plugin 210 via the TCP or UDP channel therebetween. At step 530, scanner redirection client plugin 210 sets the selected ICD. For example, according to the first embodiment, scanner redirection client plugin 210 loads the DS corresponding to the selected ICD, e.g., DS 310 if the selected ICD is flatbed scanner 130. After step 530, method 500 ends.

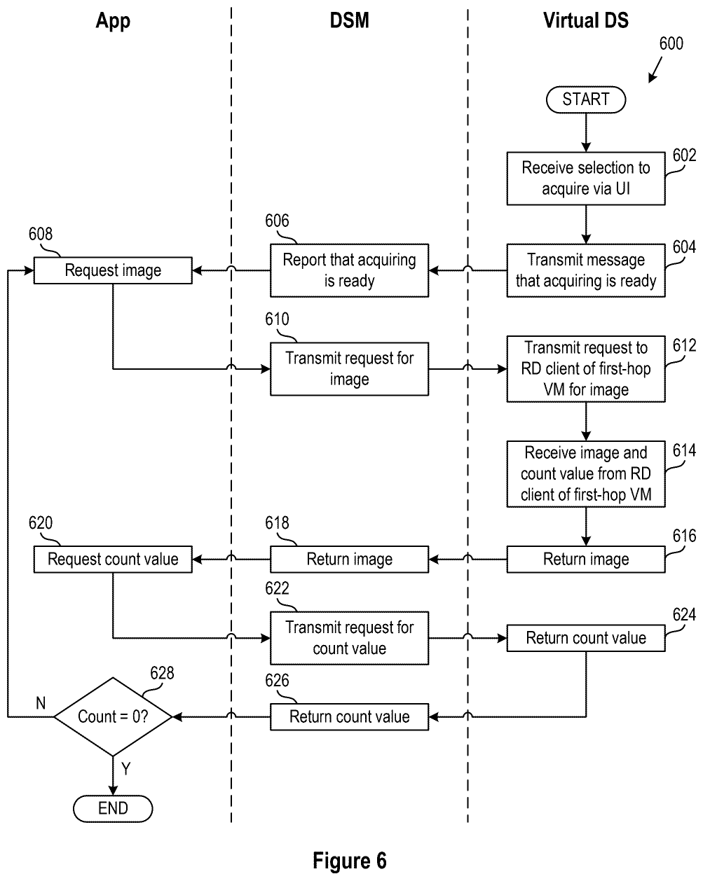

FIG. 6 is a flow diagram of a method 600 performed by second-hop VM 164-1 to acquire one or more images through scanner redirection, according to embodiments. At step 602, virtual DS 410 receives a selection via UI 418 to acquire an image. For example, the user may click an “acquire” button of UI 418 to trigger the selection. At step 604, virtual DS 410 transmits a message to DSM 400 indicating that acquiring is ready.

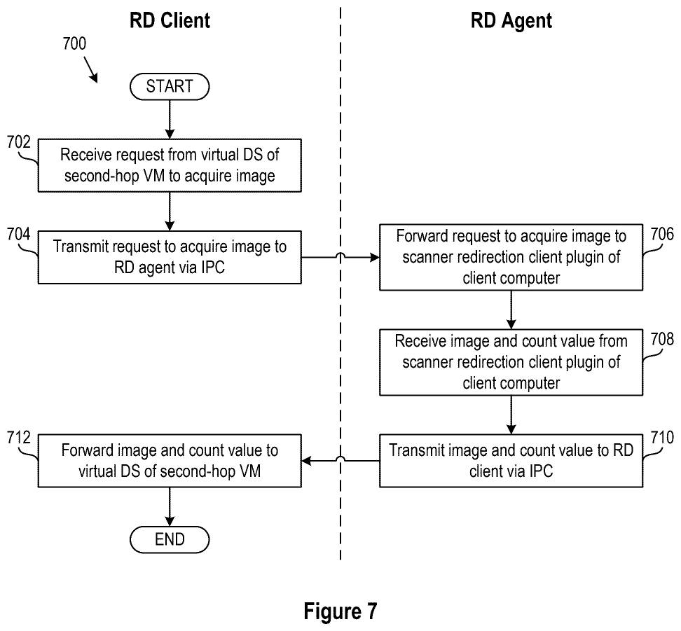

At step 606, DSM 400 reports to application 168 that acquiring is ready. At step 608, application 168 calls DSM entry 402 to request an image from DSM 400. At step 610, DSM 400 calls virtual DS entry 414 to transmit a request to virtual DS 410 for the image. At step 612, virtual DS 410 transmits a request for an image to RD client 146 of first-hop VM 144-1 via a TCP or UDP channel between agent RDPVCB plugin 270 and client RDPVCB plugin 250. Step 612 triggers the method of FIG. 7, discussed further below.

At step 614, virtual DS 410 receives the image and a “count” value from RD client 146 via the TCP or UDP channel. Count is a variable indicating whether there are any pending images yet to be acquired from a target ICD. A count value of zero indicates that there are no pending images. A nonzero count value indicates that there is at least one pending image.

At step 616, virtual DS 410 transmits the image to DSM 400 as a return value of the call to virtual DS entry 414. At step 618, DSM 400 provides the image to application 168 as a return value of the call to DSM entry 402. At step 620, application 168 calls DSM entry 402 to request DSM 400 for the count value. At step 622, DSM 400 calls virtual DS entry 414 to transmit a request to virtual DS 410 for the count value.

At step 624, virtual DS 410 transmits the count value to DSM 400 as a return value of the call to virtual DS entry 414. At step 626, DSM 400 provides the count value to application 168 as a return value of the call to DSM entry 402. At step 628, application 168 checks if the count value is zero. If the count value is nonzero, method 600 returns to step 608, and application 168 calls DSM entry 402 to request another image from DSM 400. Otherwise, if the count value is zero, method 600 ends.

FIG. 7 is a flow diagram of a method 700 performed by first-hop VM 144-1 to enable second-hop VM 164-1 to acquire an image, according to embodiments. At step 702, RD client 146 receives a request from virtual DS 410 of second-hop VM 164-1 to acquire an image, the request being received via a TCP or UDP channel between client RDPVCB plugin 250 and agent RDPVCB plugin 270. At step 704, RD client 146 transmits the request to RD agent 148 via IPC between IPC client 260 and IPC server 240. At step 706, RD agent 148 transmits (i.e., forwards) the request to scanner redirection client plugin 210 of client computer 110 via a TCP or UDP channel between agent RDPVCB plugin 230 and client RDPVCB module 220.

At step 708, RD agent 148 receives an image and a count value from scanner redirection client plugin 210 via the TCP or UDP channel therebetween. At step 710, RD agent 148 transmits the image and count value to RD client 146 via IPC between IPC server 240 and IPC client 260. At step 712, RD client 146 transmits (i.e., forwards) the image and count value to virtual DS 410 of second-hop VM 164-1 via the TCP or UDP channel therebetween. After step 712, method 700 ends.

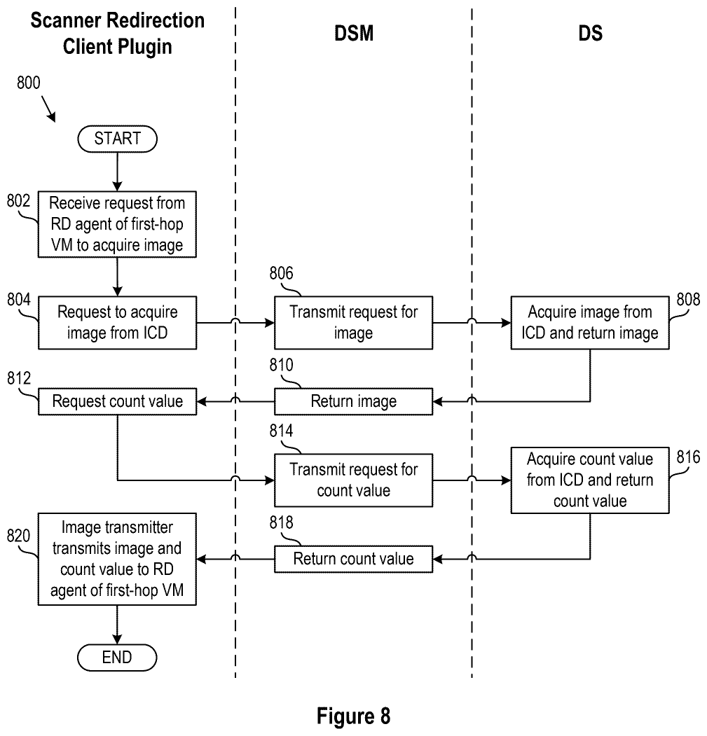

FIG. 8 is a flow diagram of a method 800 performed by client computer 110 to acquire an image for second-hop VM 164-1, according to the first embodiment. At step 802, scanner redirection client plugin 210 receives a request from RD agent 148 of first-hop VM 144-1 via a TCP or UDP channel between client RDPVCB module 220 and agent RDPVCB plugin 230. The request is to acquire an image, the request originating at second-hop VM 164-1 and being forwarded by first-hop VM 144-1. At step 804, scanner redirection client plugin 210 calls DSM entry 302 to request DSM 300 to acquire the image.

At step 806, DSM 300 calls a DS entry to transmit a request to a DS for the image. For example, if the user previously selected flatbed scanner 130 from ICD tray process 420 of second-hop VM 164-1, DSM 300 calls DS entry 312 to transmit the request to DS 310. In this example, DS 310 has already been loaded by scanner redirection client plugin 210, and DS 310 has already opened a communication session with flatbed scanner 130. At step 808, the requested DS communicates with the selected ICD (e.g., according to the TWAIN protocol) to acquire the image therefrom and transmits the image to DSM 300 as a return value of the call to the DS entry. At step 810, DSM 300 provides the image to scanner redirection client plugin 210 as a return value of the call to DSM entry 302.

At step 812, scanner redirection client plugin 210 calls DSM entry 302 to request DSM 300 for a count value. At step 814, DSM 300 calls the DS entry, e.g., DS entry 312, to transmit a request to the DS, e.g., DS 310, for the count value. At step 816, the DS acquires the count value from the selected ICD (e.g., flatbed scanner 130) and returns the count value to DSM 300 as a return value of the call to the DS entry. At step 818, DSM 300 provides the count value to scanner redirection client plugin 210 as a return value of the call to DSM entry 302. At step 820, image transmitter 340 of client computer 110 transmits the image and count value to RD agent 148 via the TCP or UDP channel therebetween. After step 820, method 800 ends.

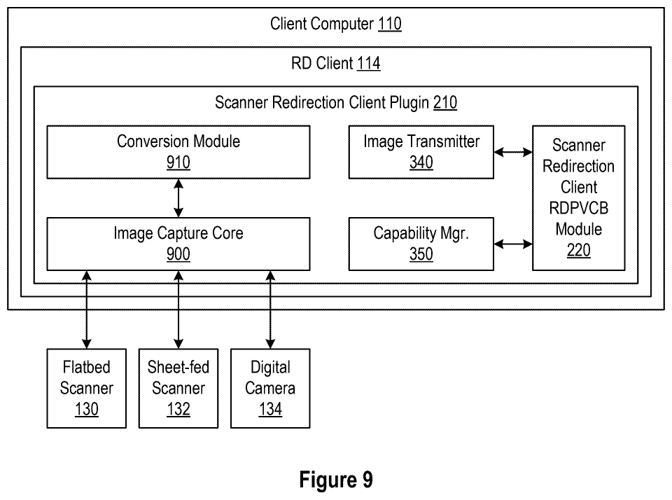

FIG. 9 is a block diagram of client computer 110 and ICDs 130, 132, and 134 connected thereto, according to the second embodiment. According to the second embodiment, client computer 110 uses a different scanning protocol (the ICA framework) than that of second-hop VM 164-1. For example, second-hop VM 164-1 may use the TWAIN protocol. As with the example of FIG. 3, in the example of FIG. 9, there are three drivers (not shown) installed for controlling flatbed scanner 130, sheet-fed scanner 132, and digital camera 134.

Communication between scanner redirection client plugin 210 and individual components thereof and communication between the individual components, are facilitated via API calls. Like the first embodiment, scanner redirection client plugin 210 includes image capturing software that communicates with ICDs to acquire images therefrom. However, according to the second embodiment, the image capturing software is, e.g., an image capture core 900 instead of one or more DSs. When image capture core 900 acquires an image from an ICD according to the ICA framework, scanner redirection client plugin 210 instructs image transmitter 340 to transmit the image to first-hop VM 144-1 via client RDPVCB module 220.

Because scanner redirection client plugin 210 uses its own scanning protocol, scanner redirection client plugin 210 includes a conversion module 910. Conversion module 910 converts data between different scanning protocols. For example, if capability manager 350 receives a request from second-hop VM 164-1 to view capabilities of a particular ICD, then once image capture core 900 acquires those capabilities, conversion module 910 converts the capabilities to the scanning protocol of second-hop VM 164-1. Scanner redirection client plugin 210 then instructs capability manager 350 to transmit them to first-hop VM 144-1 to be forwarded to second-hop VM 164-1. If capability manager 350 receives settings from second-hop VM 164-1 to apply to the ICD, scanner redirection client plugin 210 instructs conversion module 910 to convert the selected settings to the scanning protocol of client computer 110 to be understood by image capture core 900 and applied to the ICD.

According to the second embodiment, scanner redirection client plugin 210 includes image capture core 900 for utilizing the ICA framework. However, client computer 110 may instead use, e.g., the SANE API according to the third embodiment. If using the SANE API, scanner redirection client plugin 210 includes a SANE module that acquires images from flatbed scanner 130, sheet-fed scanner 132, and digital camera 134 according to the SANE API. In such example, conversion module 910 converts data between the SANE API and the scanning protocol of second-hop VM 164-1.

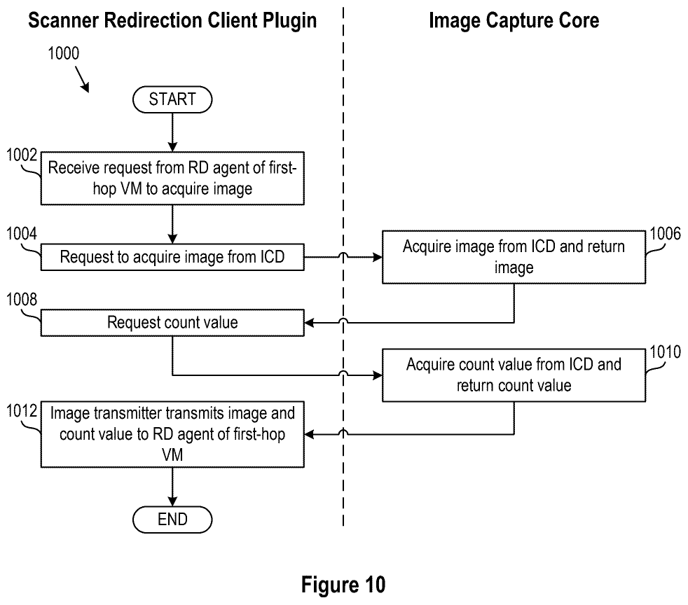

FIG. 10 is a flow diagram of a method 1000 performed by client computer 110 to acquire an image for second-hop VM 164-1, according to the second embodiment. At step 1002, scanner redirection client plugin 210 receives a request from RD agent 148 of first-hop VM 144-1 to acquire an image. The request is received over a TCP or UDP channel between client RDPVCB module 220 and agent RDPVCB plugin 230.

At step 1004, scanner redirection client plugin 210 requests image capture core 900 to acquire the image from a selected ICD by making an API call to image capture core 900. For example, if the user previously selected flatbed scanner 130 from ICD tray process 420 of second-hop VM 164-1, scanner redirection client plugin 210 has already provided this selection information to image capture core 900. In response to this selection, image capture core 900 has already opened a communication session with flatbed scanner 130. At step 1006, image capture core 900 communicates with the selected ICD according to the ICA framework to acquire the image therefrom and provides the image to scanner redirection plugin 210 as a return value of the API call.

At step 1008, scanner redirection client plugin 148 requests image capture core 900 for a count value by making another API call to image capture core 900. At step 1010, image capture core 900 acquires the count value from the selected ICD, e.g., flatbed scanner 130, and provides the count value to scanner redirection client plugin 210 as a return value of the API call. At step 1012, image transmitter 340 of scanner redirection client plugin 210 transmits the image and count value to RD agent 148 via the TCP or UDP channel therebetween. After step 1012, method 1000 ends.

It should be noted that image capture core 900 acquires images from ICDs asynchronously. For example, image capture core 900 may acquire multiple images and return them all before scanner redirection client plugin 210 requests the count value at step 1008. Additionally, as mentioned above, instead of using the ICA framework, client computer 110 may instead use, e.g., the SANE API according to the third embodiment. For example, if using the SANE API, steps discussed as being performed by image capture core 900 are instead performed by a SANE module that communicates with ICDs according to the SANE API.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest OS that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A scanner redirection method for a remote desktop computer system that includes a client computer, a first virtual machine (VM), and a second VM, wherein the client computer communicates with the first VM via a first remote desktop session, and the first VM communicates with the second VM via a second remote desktop session, the scanner redirection method comprising:
receiving by the first VM from the second VM, a request for an image and an identifier (ID) of an image capturing device connected to the client computer;
forwarding by the first VM to the client computer, the request for the image and the ID of the image capturing device, wherein in response to the request for the image, the client computer acquires the image from the image capturing device and then transmits the image to the first VM; and
upon receiving the image from the client computer, transmitting by the first VM to the second VM, the image received from the client computer.

2. The scanner redirection method of claim 1, wherein client remote desktop software in the first VM communicates with the second VM, and agent remote desktop software in the first VM communicates with the client computer.

3. The scanner redirection method of claim 2, wherein the client remote desktop software receives the request for the image and the ID of the image capturing device from the second VM and transmits the image to the second VM, and wherein the agent remote desktop software forwards the request for the image and the ID of the image capturing device to the client computer and receives the image from the client computer.

4. The scanner redirection method of claim 1, wherein the second VM transmits the ID of the image capturing device to the first VM in response to a user selection of the ID of the image capturing device via the second remote desktop session.

5. The scanner redirection method of claim 1, wherein the client computer and second VM use the same scanning protocol, and the client computer uses a data source manager and a data source separate from the data source manager to acquire the image from the image capturing device according to the TWAIN protocol.

6. The scanner redirection method of claim 1, wherein the client computer uses a different scanning protocol than that of the second VM, and the client computer uses an image capture core to acquire the image from the image capturing device according to the image capture (ICA) framework.

7. The scanner redirection method of claim 1, wherein the client computer uses a different scanning protocol than that of the second VM, and the client computer uses a scanner-access-now-easy (SANE) module to acquire the image from the image capturing device according to the SANE application programming interface (API).

8. A non-transitory computer-readable medium comprising instructions that are executable in a remote desktop computer system, wherein the instructions when executed cause the remote desktop computer system to carry out a scanner redirection method, wherein the remote desktop computer system includes a client computer, a first virtual machine (VM), and a second VM, wherein the client computer communicates with the first VM via a first remote desktop session, and the first VM communicates with the second VM via a second remote desktop session, and wherein the scanner redirection method comprises:
receiving by the first VM from the second VM, a request for an image and an identifier (ID) of an image capturing device connected to the client computer;
forwarding by the first VM to the client computer, the request for the image and the ID of the image capturing device, wherein in response to the request for the image, the client computer acquires the image from the image capturing device and then transmits the image to the first VM; and
upon receiving the image from the client computer, transmitting by the first VM to the second VM, the image received from the client computer.

9. The non-transitory computer-readable medium of claim 8, wherein client remote desktop software in the first VM communicates with the second VM, and agent remote desktop software in the first VM communicates with the client computer.

10. The non-transitory computer-readable medium of claim 9, wherein the client remote desktop software receives the request for the image and the ID of the image capturing device from the second VM and transmits the image to the second VM, and wherein the agent remote desktop software forwards the request for the image and the ID of the image capturing device to the client computer and receives the image from the client computer.

11. The non-transitory computer-readable medium of claim 8, wherein the second VM transmits the ID of the image capturing device to the first VM in response to a user selection of the ID of the image capturing device via the second remote desktop session.

12. The non-transitory computer-readable medium of claim 8, wherein the client computer and second VM use the same scanning protocol, and the client computer uses a data source manager and a data source separate from the data source manager to acquire the image from the image capturing device according to the TWAIN protocol.

13. The non-transitory computer-readable medium of claim 8, wherein the client computer uses a different scanning protocol than that of the second VM, and the client computer uses an image capture core to acquire the image from the image capturing device according to the image capture (ICA) framework.

14. The non-transitory computer-readable medium of claim 8, wherein the client computer uses a different scanning protocol than that of the second VM, and the client computer uses a scanner-access-now-easy (SANE) module to acquire the image from the image capturing device according to the SANE application programming interface (API).

15. A remote desktop computer system comprising:
a client computer;
a first virtual machine (VM) configured to communicate with the client computer via a first remote desktop session; and
a second VM configured to communicate with the first VM via a second remote desktop session, wherein the first VM is further configured to execute on a processor of a hardware platform to:
receive from the second VM, a request for an image and an identifier (ID) of an image capturing device connected to the client computer;
forward to the client computer, the request for the image and the ID of the image capturing device, wherein in response to the request for the image, the client computer acquires the image from the image capturing device and then transmits the image to the first VM; and
upon receiving the image from the client computer, transmit to the second VM, the image received from the client computer.

16. The remote desktop computer system of claim 15, wherein client remote desktop software in the first VM communicates with the second VM, and agent remote desktop software in the first VM communicates with the client computer.

17. The remote desktop computer system of claim 16, wherein the client remote desktop software receives the request for the image and the ID of the image capturing device from the second VM and transmits the image to the second VM, and wherein the agent remote desktop software forwards the request for the image and the ID of the image capturing device to the client computer and receives the image from the client computer.

18. The remote desktop computer system of claim 15, wherein the second VM transmits the ID of the image capturing device to the first VM in response to a user selection of the ID of the image capturing device via the second remote desktop session.

19. The remote desktop computer system of claim 15, wherein the client computer and second VM use the same scanning protocol, and the client computer uses a data source manager and a data source separate from the data source manager to acquire the image from the image capturing device according to the TWAIN protocol.

20. The remote desktop computer system of claim 15, wherein the client computer uses a different scanning protocol than that of the second VM, and the client computer uses an image capture core to acquire the image from the image capturing device according to the image capture (ICA) framework.
